(19) United States
(12) Patent Application Publication
(10) Pub. No.: US 2024/0335823 A1
(43) Pub. Date: Oct. 10, 2024

(54) METHODS FOR REGENERATING CATALYST SYSTEMS

(71) Applicant: Saudi Arabian Oil Company, Dhahran (SA)

(72) Inventors: Furqan Aljumah, Dhahran (SA); Sohel Shaikh, Dhahran (SA); Munir Khokhar, Dhahran (SA); Zhonglin Zhang, Dhahran (SA); Shatha Alabbad, Dhahran (SA)

(73) Assignee: Saudi Arabian Oil Company, Dhahran (SA)

(21) Appl. No.: 18/296,146

(22) Filed: Apr. 5, 2023

(51) Int. Cl. B01J 29/40; B01J 21/08; B01J 23/54; B01J 38/02; B01J 38/40; C10G 11/05

(52) U.S. Cl. CPC B01J 29/40; B01J 21/08; B01J 23/54; B01J 38/02; B01J 38/40; C10G 11/05; C10G 2400/20

(57) ABSTRACT

A catalyst system may be regenerated by a method that includes exposing the catalyst system to a de-coking treatment. The de-coking treatment may include three consecutive treatment conditions including a first treatment condition, a second treatment condition, and a third treatment condition. The catalyst system may include a metathesis catalyst and a cracking catalyst. The metathesis catalyst may include tungsten oxide and silica carrier, and the cracking catalyst may include ZSM-5 zeolite.

### TECHNICAL FIELD

Embodiments of the present disclosure generally relate to chemical processing and, more specifically, to processes and systems utilized to regenerate catalysts.

### BACKGROUND

Propylene is a valuable chemical intermediate that may be formed into useful materials such as polypropylene. They are usually obtained through steam pyrolysis of petroleum gases and distillates such as naphtha, kerosene or even gas oil. However, some have developed methods to form propylene from butene. The butene may be metathesized to form propylene and 2-pentene. The 2-pentene may then be cracked to form additional propylene.

### SUMMARY

During processing of butene to form propylene, it is observed that the propylene yield decreases over time. The catalyst system utilized in the system may become coked, and coke may need to be removed through a regeneration process to increase propylene yield. The presently disclosed embodiments relate to methods for regenerating catalyst systems. Generally, the catalyst systems may be suitable for formation of propylene from butene, and may comprise a metathesis catalyst and a cracking catalyst. The methods described herein utilize particular treatment conditions, as are described. These conditions include particular temperatures and oxygen concentrations. The treatment conditions may promote the formation of carbon monoxide when coke is burned in the regeneration. The production of CO may be advantageous because, in one or more embodiments, CO may be utilized for metal reduction on the metathesis catalyst system, eliminating the need for a supplemental reducing gas such as hydrogen or NO.

According to one or more embodiments, a catalyst system may be regenerated by a method comprising exposing the catalyst system to a de-coking treatment. The de-coking treatment may comprise three consecutive treatment conditions comprising a first treatment condition, a second treatment condition, and a third treatment condition. The catalyst system may comprise a metathesis catalyst and a cracking catalyst. The metathesis catalyst may comprise tungsten oxide and silica carrier, and the cracking catalyst may comprise ZSM-5 zeolite. The first treatment condition may have a first average temperature and a first average oxygen concentration. The second treatment condition may have a second average temperature and a second average oxygen concentration. The first average temperature may be less than the second average temperature, and the first average oxygen concentration may be less than the second average oxygen concentration. The third treatment condition may have a third average temperature and a third average oxygen concentration. The second average temperature may be less than the third average temperature, and the second average oxygen concentration may be less than the third average oxygen concentration.

According to one or more additional embodiments, propylene may be formed by a method comprising forming propylene from butene by passing a stream comprising butene into contact with a catalyst system comprising a metathesis catalyst and a cracking catalyst to from propylene, stopping the reacting of the butene to form propylene, and removing coke from the catalyst system. Removing the coke from the catalyst system may comprise exposing the catalyst system to a de-coking treatment comprising three consecutive treatment conditions comprising a first treatment condition, a second treatment condition, and a third treatment condition. The catalyst system may comprise a metathesis catalyst and a cracking catalyst. The first treatment condition may comprise a first average temperature and a first average oxygen concentration. The second treatment condition may comprise a second average temperature and a second average oxygen concentration. The first average temperature may be less than the second average temperature, and the first average oxygen concentration may be less than the second average oxygen concentration. The third treatment condition may comprise a third average temperature and a third average oxygen concentration. The second average temperature may be less than the third average temperature, and the second average oxygen concentration may be less than the third average oxygen concentration.

Additional features and advantages of the described embodiments will be set forth in the detailed description which follows, and in part will be readily apparent to those skilled in the art from that description or recognized by practicing the described embodiments, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a chart depicting catalyst deactivation over time of an example embodiment, according to one or more embodiments described in this disclosure;

FIG. 2 is a chart depicting an example embodiment of temperature and oxygen concentration over time of a regeneration treatment, according to one or more embodiments described in this disclosure;

FIG. 3 is a chart depicting and example embodiment of CO and CO₂ formation during regeneration, according to one or more embodiments described in this disclosure; and

FIG. 4 is a chart depicting an example embodiment of product yields following regeneration, according to one or more embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Embodiments of the present disclosure related to methods for regenerating catalyst systems. The regeneration process may comprise exposing the catalyst system to a de-coking treatment. Generally, the catalyst system may include coke following its use in a commercial reaction process such as metathesis and cracking. Surprisingly, it was found that carbon deposits on the spent catalyst may be as great as 50 wt. %.

In one or more embodiments, the catalyst system includes a cracking catalyst and a metathesis catalyst. In some embodiments, the catalyst system consists of the cracking catalyst and metathesis catalyst. The cracking catalyst and metathesis catalyst may be in a fixed bed reactors, arranged in a series, or may be mixed. The metathesis catalyst may be upstream of the cracking catalyst. In additional embodiments, the metathesis catalyst and the cracking catalyst are is separate reactors arranged in series.

In operation, the cracking metathesis catalyst and cracking catalyst may be utilized to form propylene from a stream that includes butane. In embodiments, propylene may be formed from butene by passing a stream comprising butene into contact with the catalyst system. Examples of such processing include the systems and methods of U.S. Pat. Nos. 10,329,225 and 9,834,497, each of which is incorporated by reference in its entirety herein.

In embodiments, the catalyst system may be utilized to metathesize butane to form propylene and 2-pentene. Such reaction may be promoted by the metathesis catalyst in the catalyst system. The 2-pentene may be cracked to from additional propylene, which may be promoted by the cracking catalyst.

According to embodiments, the metathesis catalyst may comprise or consist of tungsten oxide and silica carrier. In some embodiments, the metathesis catalyst may be made by a process that includes impregnating tungsten oxide on silica support in the presence of a precursor to produce a base catalyst; calcining the base catalyst, dispersing a solid metal-based co-catalyst onto the surface of the base catalyst to produce a doped catalyst; and calcining the doped catalyst to produce a metathesis catalyst system. Without limitation, the catalysts of EP3863764, entitled “Catalysts that Include Metal Oxide Co-catalysts for the Production of Propylene,” which is incorporated by reference herein, may be utilized in the embodiments herein.

According to embodiments, the cracking catalyst may comprise or consist of ZSM-5 zeolite. As used in this disclosure, “ZSM-5” generally refers to zeolites having an MFI framework type according to the IZA zeolite nomenclature and consisting majorly of silica and alumina, as is understood by those skilled in the art. ZSM-5 refers to “Zeolite Socony Mobil-5” and is a pentasil family zeolite that can be represented by the chemical formula NaₙAlₙSi₉₆₋ₙO₁₉₂·16H₂O, where 0<n<27. According to one or more embodiments, the molar ratio of silica to alumina in the ZSM-5 may be at least 5. For example, the molar ratio of silica to alumina in the ZSM-5 zeolite may be at least 10, at least 12, or even at least 30, such as from 5 to 30, from 12 to 30, from 5 to 80, from 5 to 300, from 5 to 1000, or even from 5 to 1500. Examples of suitable ZSM-5 zeolite include those commercially available from Zeolyst International, such as CBV2314, CBV3024E, CBV5524G, and CBV28014, and from TOSOH Corporation, such as HSZ-890 and HSZ-891.

During normal operation of the conversion of butene to propylene as described herein, it has been observed that propylene yield is significantly reduced over time. It has been found that coking of the catalyst system may be the cause of the yield reduction. In order to reactivate the catalyst by removal of coke, the reaction process may be stopped in the reactor. It should be understood that “stopping the reaction” as described herein includes any stoppage of a reactor, even when a parallel reactor may operate in a swing mode. Following the stopping of the reaction, the catalyst system may undergo a de-coking treatment as described herein.

The de-coking treatment may include a three consecutive treatment conditions. These treatment conditions include a first treatment condition, a second treatment condition, and a third treatment condition. The first treatment condition, second treatment condition, and third treatment condition are consecutive, meaning back-to-back with no time in-between.

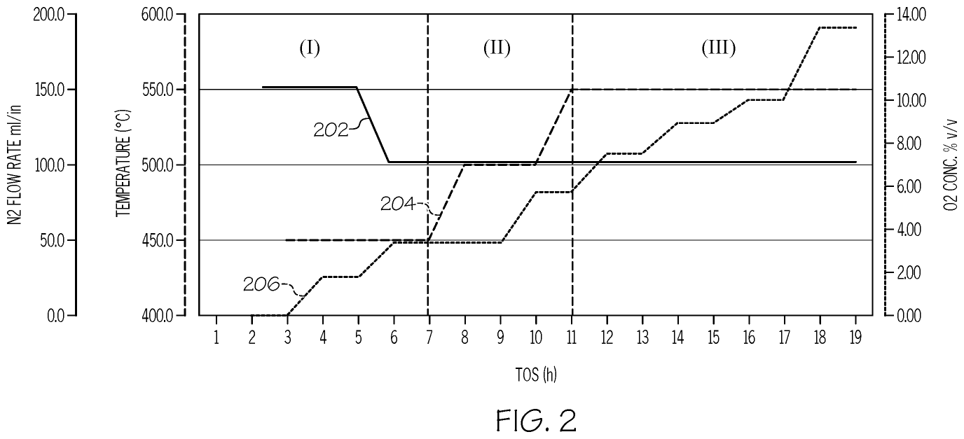

Each treatment condition is characterized by a temperature regime, an oxygen concentration regime, and a length of time. Details of embodiments of the temperatures and oxygen concentrations utilized is the first treatment condition, second treatment condition, and third treatment condition are described in detail herein. FIG. 2 is representative of an example de-coking treatment, where (I) represents the first treatment condition, (II) represents the second treatment condition, and (III) represents the third treatment condition. The second treatment condition follows the first treatment condition and the third treatment condition follows the second treatment condition. In FIG. 2, line 202 represents nitrogen flow rate, line 204 represents temperature, and line 206 represents oxygen concentration. It should be understood that those skilled in the would recognize that the temperatures, oxygen concentrations, and time of each of the treatment conditions may vary to some degree as compared with those shown in FIG. 2. FIG. 2 is described in detail in the examples that follow.

In one or more embodiments, the first treatment condition, the second treatment condition, and the third treatment condition each have an average temperature and an average oxygen concentration. As described herein, the “average temperature” refers to an average of the temperature throughout the time period of the specified treatment condition. Likewise, “average oxygen concentration” refers to an average of the oxygen concentration throughout the time period of the specified treatment condition.

As described herein, the “first average temperature” refers to the average temperature during the first treatment condition, the “second average temperature” refers to the average temperature during the second treatment condition, and the “third average temperature” refers to the average temperature during the third treatment condition. Likewise, the “first average oxygen concentration” refers to the average oxygen concentration during the first treatment condition, the “second average oxygen concentration” refers to the average oxygen concentration during the second treatment condition, and the “third average oxygen concentration” refers to the average oxygen concentration during the third treatment condition. Thus, the first treatment condition has a first average temperature and a first average oxygen concentration, the second treatment condition has a second average temperature and a first average oxygen concentration, and the third treatment condition has a third average temperature and a third average oxygen concentration.

The catalyst system may increase or remain substantially constant in temperature throughout the de-coking treatment. Additionally, in one or more embodiments, the catalyst system may be exposed to increasing or substantially constant oxygen concentration throughout the de-coking treatment.

In embodiments, the first average temperature is less than the second average temperature, and the first average oxygen concentration is less than the second average oxygen concentration. Additionally, in one or more embodiments, the second average temperature is less than the third average temperature, and the second average oxygen concentration is less than the third average oxygen concentration.

Without being bound by any particular theory, it is believed that as there is an increase in temperature from first average temperature to second average temperature, and the first average oxygen concentration increases as compared to that of the second average oxygen concentration, coke is reduced on the catalyst in a relatively slow manner, which may be beneficial for total catalyst regeneration without degradation of the catalytic structure.

In the embodiments described herein, the second average temperature is greater than the first average temperature. According to embodiments, the second average temperature may be at least 5° C. greater, at least 10° C. greater, at least 15° C. greater, at least 20° C. greater, at least 25° C. greater, at least 30° C. greater, at least 35° C. greater, at least 40° C. greater, or even at least 45° C. greater than the first average temperature.

In the embodiments described herein, the third average temperature is greater than the second average temperature. According to embodiments, the third average temperature may be at least 5° C. greater, at least 10° C. greater, at least 15° C. greater, at least 20° C. greater, at least 25° C. greater, at least 30° C. greater, at least 35° C. greater, at least 40° C. greater, or even at least 45° C. greater than the first average temperature.

In the embodiments described herein, the second average oxygen concentration is greater than the first average oxygen concentration. According to embodiments, the second average oxygen concentration may be at least 0.5 mol. % greater, at least 1 mol. % greater, at least 1.5 mol. % greater, at least 2 mol. % greater, at least 2.5 mol. % greater, or even at least 3 mol. % greater than the first average oxygen concentration. Such increases in oxygen concentration may de-coke the catalyst without hindering the intrinsic properties of the catalyst.

In the embodiments described herein, the third average oxygen concentration is greater than the second average oxygen concentration. According to embodiments, the third average oxygen concentration may be at least 0.5 mol. % greater, at least 1 mol. % greater, at least 1.5 mol. % greater, at least 2 mol. % greater, at least 2.5 mol. % greater, or even at least 3 mol. % greater than the second average oxygen concentration. This increase in oxygen concentration is beneficial for de-coking since combustion may take place more easily in greater concentrations of oxygen.

In one or more embodiments, the first average temperature may be from 400° C. to 500° C. For example, the first average temperature may be from 400° C. to 410° C., from 410° C. to 420° C., from 420° C. to 430° C., from 430° C. to 440° C., from 440° C. to 450° C., from 450° C. to 460° C., from 460° C. to 470° C., from 470° C. to 480° C. from 480° C. to 490° C., from 490° C. to 500° C., or any combination of these ranges.

In one or more embodiments, the first treatment condition may consist of temperatures of from 400° C. to 500° C. For example, the first treatment condition may consist of temperature of from 400° C. to 410° C., from 410° C. to 420° C., from 420° C. to 430° C., from 430° C. to 440° C., from 440° C. to 450° C., from 450° C. to 460° C., from 460° C. to 470° C., from 470° C. to 480° C. from 480° C. to 490° C., from 490° C. to 500° C., or any combination of these ranges.

In one or more embodiments, the first average oxygen concentration may be from 0 mol. % to 4 mol. %. For example, the first average oxygen concentration may be from 0 mol. % to 0.5 mol. %, from 0.5 mol. % to 1 mol. %, from 1 mol. % to 1.5 mol. %, from 1.5 mol. % to 2 mol. %, from 2 mol. % to 2.5 mol. %, from 2.5 mol. % to 3 mol. %, from 3 mol. % to 3.5 mol. %, from 3.5 mol. % to 4 mol. %, or any combination of these ranges. Incremental oxygen concentration increases in the first treatment condition of, for example, 5° C. or more allow for decoking while maintaining catalytic stability.

In one or more embodiments, the first treatment condition may have a time of from 5 hours to 10 hours. For example, the first treatment condition may have a time of from 5 hours to 5.5 hours, from 5.5 hours to 6 hours, from 6 hours to 6.5 hours, from 6.5 hours to 7 hours, from 7 hours to 7.5 hours, from 7.5 hours to 8 hours, from 8 hours to 8.5 hours, from 8.5 hours to 9 hours from 9 hours to 9.5 hours, from 9.5 hours to 10 hours, or any combination of these ranges.

Surprisingly, it was found that contacting the catalyst system with oxygen in the described concentrations at the described temperatures of the first treatment condition did not cause unreasonable thermal stress on the catalyst bed or reactor structure. Moreover, hot spots may not be present in the conditions of the first treatment.

In one or more embodiments, the second average temperature may be from 450° C. to 550° C. For example, the second average temperature may be from 450° C. to 460° C., from 460° C. to 470° C. from 470° C. to 480° C., from 480° C. to 490° C., from 490° C. to 500° C., from 500° C. to 510° C. from 510° C. to 520° C., from 520° C. to 530° C. from 530° C. to 540° C., from 540° C. to 550° C., or any combination of these ranges. In some embodiments, in the second treatment condition, the temperature may raise at a rate of, for example, 10° C./min, such as from 9° C./min to 11° C./min, or from 8° C./min to 12° C./min.

In one or more embodiments, the second treatment condition may consist of temperatures of from 425° C. to 575° C. For example, the second treatment condition may consist of temperatures of from 425° C. to 430° C., from 430° C. to 440° C., from 440° C. to 450° C., from 450° C. to 460° C., from 460° C. to 470° C., from 470° C. to 480° C., from 480° C. to 490° C., from 490° C. to 500° C. from 500° C. to 510° C., from 510° C. to 520° C., from 520° C. to 530° C. from 530° C. to 540° C., from 540° C. to 550° C. from 550° C. to 560° C., from 560° C. to 570° C. from 570° C. to 575° C., or any combination of these ranges.

In one or more embodiments, the second average oxygen concentration may be from 3 mol. % to 8 mol. %. For example, the second average oxygen concentration may be from 3 mol. % to 3.5 mol. %, from 3.5 mol. % to 4 mol. %, from 4 mol. % to 4.5 mol. %, from 4.5 mol. % to 5 mol. %, from 5 mol. % to 5.5 mol. %, from 5.5 mol. % to 6 mol. %, from 6 mol. % to 6.5 mol. %, from 6.5 mol. % to 7 mol. % from 7 mol. % to 7.5 mol. %, from 7.5 mol. % to 8 mol. %, or any combination of these ranges.

In one or more embodiments, the second treatment condition may have a time of from 2 hours to 6 hours. For example, the second treatment condition may have a time of from 2 hours to 2.5 hours, from 2.5 hours to 3 hours, from 3 hours to 3.5 hours, from 3.5 hours to 4 hours, from 4 hours to 4.5 hours, from 4.5 hours to 5 hours, from 5 hours to 5.5 hours, from 5.5 hours to 6 hours, or any combination of these ranges.

In one or more embodiments, the third average temperature may be from 500° C. to 600° C. For example, the third average temperature may be from 500° C. to 510° C., from 510° C. to 520° C., from 520° C. to 530° C., from 530° C. to 540° C., from 540° C. to 550° C., from 550° C. to 560° C., from 560° C. to 570° C., from 570° C. to 580° C. from 580° C. to 590° C., from 590° C. to 600° C., or any combination of these ranges. In one or more embodiments, the third treatment condition may have an average temperature of at least 525° C., at least 530° C., at least 535° C., at least 540° C., or even at least 550° C. In some embodiments, in the third treatment condition, the temperature may raise at a rate of, for example, 10° C./min, such as from 9° C./min to 11° C./min, or from 8° C./min to 12° C./min.

In one or more embodiments, the third treatment consists of temperatures of from 500° C. to 600° C. For example, the third treatment consists of temperatures of from 500° C. to 510° C., from 510° C. to 520° C., from 520° C. to 530° C., from 530° C. to 540° C., from 540° C. to 550° C., from 550° C. to 560° C., from 560° C. to 570° C., from 570° C. to 580° C. from 580° C. to 590° C., from 590° C. to 600° C., or any combination of these ranges. In one or more embodiments, the third treatment condition may have an average temperature of at least 525° C., at least 530° C., at least 535° C., at least 540° C., or even at least 550° C.

In one or more embodiments, the third average oxygen concentration may be from 8 mol. % to 14 mol. %. For example, the third average oxygen concentration may be from 8 mol. % to 8.5 mol. %, from 8.5 mol. % to 9 mol. %, from 9 mol. % to 9.5 mol. %, from 9.5 mol. % to 10 mol. %, from 10 mol. % to 10.5 mol. %, from 10.5 mol. % to 11 mol. %, from 11 mol. % to 11.5 mol. %, from 11.5 mol. % to 12 mol. % from 12 mol. % to 12.5 mol. %, from 12.5 mol. % to 13 mol. %, from 13 mol. % to 13.5 mol. %, from 13.5 mol. % to 14 mol. %, or any combination of these ranges. The concentration of oxygen may raise over the third treatment condition at least 0.5 mol. %, at least 1 mol. %, or even greater, which controls the decoking. f

In one or more embodiments, the third treatment condition may have a time of from 5 hours to 10 hours. For example, the third treatment condition may have a time of from 5 hours to 5.5 hours, from 5.5 hours to 6 hours, from 6 hours to 6.5 hours, from 6.5 hours to 7 hours, from 7 hours to 7.5 hours, from 7.5 hours to 8 hours, from 8 hours to 8.5 hours, from 8.5 hours to 9 hours from 9 hours to 9.5 hours, from 9.5 hours to 10 hours, or any combination of these ranges.

In one or more embodiments, the total time of the first treatment condition, the second treatment condition, and the third treatment condition may be from 10 hours to 30 hours. For example, the total time of the first treatment condition, the second treatment condition, and the third treatment condition may be from 10 hours to 12 hours, from 12 hours to 14 hours, from 14 hours to 16 hours, from 16 hours to 18 hours, from 18 hours to 20 hours, from 20 hours to 22 hours, from 22 hours to 24 hours, from 24 hours to 26 hours from 26 hours to 28 hours, from 28 hours to 30 hours, or any combination of these ranges. It is believed that the de-coking procedure may have a reduced total time as compared with conventional processes. Such conventional processes may require additional steps such as contacting the catalyst with reducing agents or steam. Contacting by reducing agents and/or steam may not be included in some embodiments of the present disclosure.

Without being bound by theory, it is believed that the gradual rise in temperature over the totality of the process described herein may help to maintain the structure of the catalyst. Temperature changes that are severe may destructure the catalyst, which is undesirable.

According to one or more embodiments described herein, the oxygen concentration and temperature regime of the de-coking treatment may advantageously form CO gas in addition to CO₂ gas. Without being bound by any particular theory, it is believed that the CO gas may be utilized for metal reduction on the metathesis catalyst. This may eliminate the need for contacting the de-coked catalyst system with supplemental reducing agents such as H₂ and or NO.

In one or more embodiments, the yield of propylene is actually increased following the regeneration of the catalyst by the presently disclosed de-coking treatments. That is, a run following the de-coking may actually produce enhanced yields of propylene as compared with a run prior to a de-coking treatment.

Multiple aspects of the presently disclosed technology are included herein. One embodiment is a method for regenerating a catalyst system, the method comprising: exposing the catalyst system to a de-coking treatment comprising three consecutive treatment conditions comprising a first treatment condition, a second treatment condition, and a third treatment condition, wherein: the catalyst system comprises a metathesis catalyst and a cracking catalyst, wherein the metathesis catalyst comprises tungsten oxide and silica carrier, and the cracking catalyst comprises ZSM-5 zeolite; the first treatment condition has a first average temperature and a first average oxygen concentration; the second treatment condition has a second average temperature and a second average oxygen concentration, the first average temperature is less than the second average temperature, and the first average oxygen concentration is less than the second average oxygen concentration; the third treatment condition has a third average temperature and a third average oxygen concentration, the second average temperature is less than the third average temperature, and the second average oxygen concentration is less than the third average oxygen concentration.

Another aspect includes any previous aspect, wherein the de-coking treatment forms carbon dioxide gas.

Another aspect includes any previous aspect, wherein the catalyst system increases or remains substantially constant in temperature throughout the de-coking treatment.

Another aspect includes any previous aspect, wherein the catalyst system is exposed to increasing or substantially constant oxygen concentration throughout the de-coking treatment.

Another aspect includes any previous aspect, wherein the third treatment condition has a temperatures of at least 525° C.

Another aspect includes any previous aspect, wherein the first average temperature is from 400° C. to 500° C.; the second average temperature is from 450° C. to 550° C.; and the third average temperature 500° C. to 600° C.

Another aspect includes any previous aspect, wherein: the first average oxygen concentration is from 0 mol. % to 4 mol. %; the second average oxygen concentration is from 3 mol. % to 8 mol. %; and the third average oxygen concentration is from 8 mol. % to 14 mol. %.

Another aspect includes any previous aspect, wherein: the first treatment condition has a time of from 5 hours to 10 hours; the second treatment condition has a time of from 2 hours to 6 hours; and the third treatment condition has a time of from 5 hours to 10 hours.

Another aspect includes any previous aspect, wherein the total time of the first treatment condition, the second treatment condition, and the third treatment condition is from 10 to 30 hours.

Another aspect includes any previous aspect, wherein: the first treatment condition consists of temperatures of from 400° C. to 500° C.; the second treatment condition consists of temperatures of from 425° C. to 575° C.; and the third treatment condition consists of temperature of from 500° C. to 600° C.

Another aspect includes any previous aspect, wherein the catalyst system is suitable for producing propylene from butene.

Another aspect includes any previous aspect, wherein: the first average temperature is from 400° C. to 500° C.; the second average temperature is from 450° C. to 550° C.; the third average temperature 500° C. to 600° C.; the first average oxygen concentration is from 0 mol. % to 4 mol. %; the second average oxygen concentration is from 3 mol. % to 8 mol. %; and the third average oxygen concentration is from 8 mol. % to 14 mol. %.

Another aspect is a method for forming propylene, the method comprising: forming propylene from butene by passing a stream comprising butene into contact with a catalyst system comprising a metathesis catalyst and a cracking catalyst to from propylene; stopping the reacting of the butene to form propylene; and removing coke from the catalyst system by a process comprising: exposing the catalyst system to a de-coking treatment comprising three consecutive treatment conditions comprising a first treatment condition, a second treatment condition, and a third treatment condition, wherein: the catalyst system comprises a metathesis catalyst and a cracking catalyst; the first treatment condition comprises a first average temperature and a first average oxygen concentration; the second treatment condition comprises a second average temperature and a second average oxygen concentration, the first average temperature is less than the second average temperature, and the first average oxygen concentration is less than the second average oxygen concentration; the third treatment condition comprises a third average temperature and a third average oxygen concentration, the second average temperature is less than the third average temperature, and the second average oxygen concentration is less than the third average oxygen concentration.

Another aspect includes any previous aspect, wherein the de-coking treatment forms carbon dioxide gas.

Another aspect includes any previous aspect, wherein the catalyst system increases or remains substantially constant in temperature throughout the de-coking treatment.

Another aspect includes any previous aspect, wherein the catalyst system is exposed to increasing or substantially constant oxygen concentration throughout the de-coking treatment.

Another aspect includes any previous aspect, wherein the third treatment condition has a temperatures of at least 525° C.

Another aspect includes any previous aspect, wherein: the first average temperature is from 400° C. to 500° C.; the second average temperature is from 450° C. to 550° C.; and the third average temperature 500° C. to 600° C.

Another aspect includes any previous aspect, wherein: the first average oxygen concentration is from 0 mol. % to 4 mol. %; the second average oxygen concentration is from 3 mol. % to 8 mol. %; and the third average oxygen concentration is from 8 mol. % to 14 mol. %.

Another aspect includes any previous aspect, wherein: the first treatment condition has a time of from 5 hours to 10 hours; the second treatment condition has a time of from 2 hours to 6 hours; and the third treatment condition has a time of from 5 hours to 10 hours.

### EXAMPLES

The various embodiments of methods and systems described herein will be further clarified by the following examples. The examples are illustrative in nature, and should not be understood to limit the subject matter of the present disclosure.

### Example 1—Deactivation of Catalyst System

A dual layer of metathesis catalyst (10 wt. % WO3/SiO₂) and cracking catalyst (ZSM-5 zeolite) were loaded consecutively into a fixed bed reactor with 15 mm inner diameter in 1:1 mass ratio (2 g total) and separated by glass wool. The catalyst system was activated by passing N₂ gas at 550° C. and atmospheric pressure for 8 hours and then contacted by a mixed C4 feed. The feed stream was composed of the feed of Table 1. Butadiene was extracted or selectively hydrogenated before the reaction.

TABLE 1

| Feed | Wt. % |
|---|---|
| i-Butane | 10.0 |
| n-Butane | 20.0 |
| Cis-2-butene | 12.5 |
| Trans-2-butene | 12.5 |
| i-butene | 0.0 |
| 1-butene | 45.0 |
| Buta-1,3-diene | 0.0 |

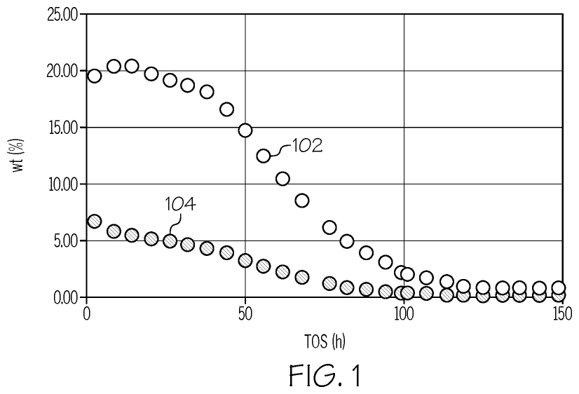

The reaction conditions for deactivation were 550° C., atmospheric pressure, WHSV of 5/h. These conditions were more severe than generally utilized in industry, but were utilized to accelerate the deactivation of the catalyst. The deactivation can be observed in FIG. 1, which depicts propene yield 102 and ethene yield 104. As is depicted, substantial deactivation occurs over time. Products at the start of the reaction are shown in Table 2.

TABLE 2

| Product | Wt. % |
|---|---|
| Methane | 0.80 |
| Ethane | 0.87 |
| Ethene | 6.10 |
| Propane | 2.47 |
| Propene | 20.77 |
| i-Butane | 10.57 |
| n-Butane | 20.06 |
| Cis-2-butene | 4.59 |
| Trans-2-butene | 3.48 |
| i-butene | 6.69 |
| 1-butene | 4.05 |
| C5 | 8.92 |
| Buta-1,3-diene | 0.11 |
| C6 | 3.31 |
| Benzene | 1.04 |
| Toluene | 2.20 |
| Xylene | 3.42 |
| C8+ | 0.55 |
| Total | 100.00 |

Coke formation on the catalyst is shown in Table 3, as well as BET porosity.

TABLE 3

| | Fresh | Spent | | |
|---|---|---|---|---|
| Catalyst | WO₃/SiO₂ | WO₃/SiO₂ | Fresh ZSM-5 | Spent ZSM-5 |
| BET (m²/g) | 301 | 0.1186 | 348.5 | 1.39 |
| Coke Mass (g) | — | 2.12 | — | 1.998 |

### Example 2—Regeneration of Deactivated Catalyst System

The regeneration process started by cooling down the reactor temperature to 450° C. while purging with N₂ at a rate of 150 ml/g before introducing oxygen containing gas. For catalyst decoking, a mixture of air and N₂ is used where the oxygen content was increased stepwise from 1.5-14 vol. %. At the same time, the oxidation temperature was increased stepwise to 550° C. The whole regeneration process took place at atmospheric pressure. The process parameters are illustrated in in FIG. 2. Line 202 represents nitrogen flow rate, line 204 represents temperature, and line 206 represents oxygen concentration.

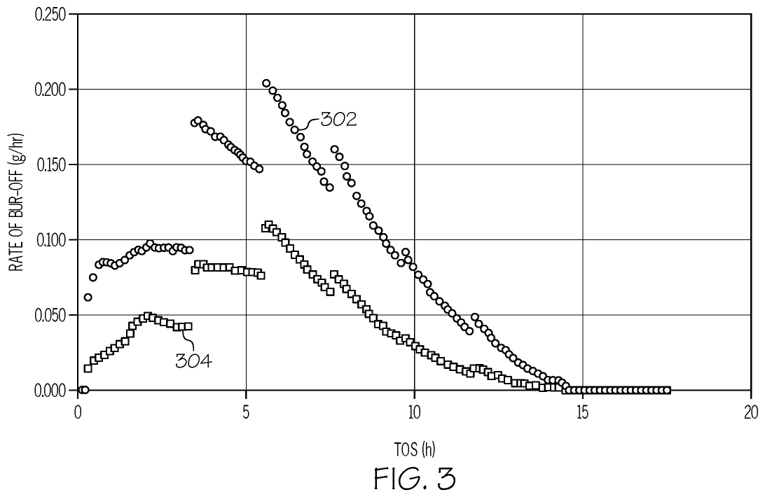

FIG. 3 depicts carbon monoxide and carbon dioxide production by the burning of coke on the catalyst mixture. Points 302 show carbon dioxide formation and points 304 show carbon monoxide formation. Carbon monoxide and carbon dioxide were measure by infra-red process analyzer.

Table 4 shows catalyst materials in fresh state and following accelerated deactivation (from Example 1), as well as after regeneration (in Example 3). Metal content for metathesis catalyst was analyzed using XRF.

TABLE 4

| Element | Fresh Metathesis | Spent Metathesis | Regenerated |
|---|---|---|---|
| Al | — | 1.08 | — |
| Si | 67.8 | 54.43 | 68.23 |
| Ca | 0.5 | 0.67 | 0.39 |
| Fe | — | 0.51 | 0.07 |
| W | 31.64 | 42.64 | 31.31 |

### Example 3—Catalytic Performance Following Regeneration

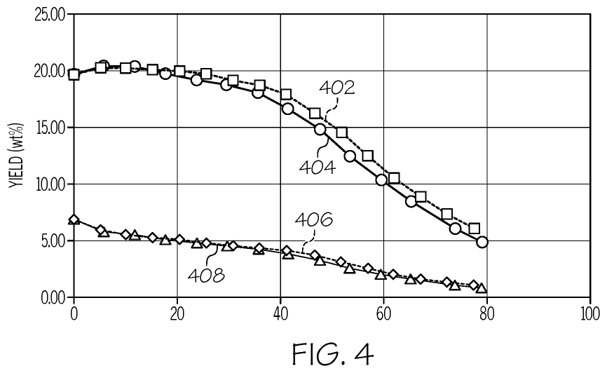

The process of Example 1 was run with the regenerated catalyst from Example 2. FIG. 4 shows propene and ethene yields of the fresh and regenerated catalyst. Line 402 represents propene yield with the regenerated catalyst. Line 404 represents propene yield with the fresh catalyst. Line 404 represents ethene yield with the regenerated catalyst. Line 404 represents ethene yield with the fresh catalyst. As shown, propene and ethene yields actually increased with the regenerated catalyst as compared to the fresh catalyst.

Table 5 shows the products at the start of the reaction, using the regenerated catalyst.

TABLE 5

| Product | Wt % |
|---|---|
| Methane | 0.81 |
| Ethane | 0.90 |
| Ethene | 5.94 |
| Propane | 2.43 |
| Propene | 20.62 |
| i-Butane | 10.43 |
| n-Butane | 20.06 |
| Cis-2-butene | 4.64 |
| Trans-2-butene | 3.51 |
| i-butene | 6.61 |
| 1-butene | 4.09 |
| C5 | 9.34 |
| Buta-1,3-diene | 0.11 |
| C6 | 3.41 |
| Benzene | 1.06 |
| Toluene | 2.20 |
| Xylene | 3.28 |
| C8+ | 0.59 |
| Total | 100.00 |

The testing was repeated for 5 cycles. Catalytic performance was maintained through the 5 cycles.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B and C should be interpreted as also disclosing a composition “consisting of” components A, B, and C as well as a composition “consisting essentially of” components A, B, and C.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A method for regenerating a catalyst system, the method comprising:
exposing the catalyst system to a de-coking treatment comprising three consecutive treatment conditions comprising a first treatment condition, a second treatment condition, and a third treatment condition, wherein:
the catalyst system comprises a metathesis catalyst and a cracking catalyst, wherein the metathesis catalyst comprises tungsten oxide and silica carrier, and the cracking catalyst comprises ZSM-5 zeolite;
the first treatment condition has a first average temperature and a first average oxygen concentration;
the second treatment condition has a second average temperature and a second average oxygen concentration, the first average temperature is less than the second average temperature, and the first average oxygen concentration is less than the second average oxygen concentration;
the third treatment condition has a third average temperature and a third average oxygen concentration, the second average temperature is less than the third average temperature, and the second average oxygen concentration is less than the third average oxygen concentration.

2. The method of claim 1, wherein the de-coking treatment forms carbon dioxide gas.

3. The method of claim 1, wherein the catalyst system increases or remains substantially constant in temperature throughout the de-coking treatment.

4. The method of claim 1, wherein the catalyst system is exposed to increasing or substantially constant oxygen concentration throughout the de-coking treatment.

5. The method of claim 1, wherein the third treatment condition has a temperatures of at least 525° C.

6. The method of claim 1, wherein:
the first average temperature is from 400° C. to 500° C.;
the second average temperature is from 450° C. to 550° C.; and
the third average temperature 500° C. to 600° C.

7. The method of claim 1, wherein:
the first average oxygen concentration is from 0 mol. % to 4 mol. %;
the second average oxygen concentration is from 3 mol. % to 8 mol. %; and
the third average oxygen concentration is from 8 mol. % to 14 mol. %.

8. The method of claim 1, wherein:
the first treatment condition has a time of from 5 hours to 10 hours;
the second treatment condition has a time of from 2 hours to 6 hours; and
the third treatment condition has a time of from 5 hours to 10 hours.

9. The method of claim 1, wherein the total time of the first treatment condition, the second treatment condition, and the third treatment condition is from 10 to 30 hours.

10. The method of claim 1, wherein:
the first treatment condition consists of temperatures of from 400° C. to 500° C.;
the second treatment condition consists of temperatures of from 425° C. to 575° C.; and
the third treatment condition consists of temperature of from 500° C. to 600° C.

11. The method of claim 1, wherein the catalyst system is suitable for producing propylene from butene.

12. The method of claim 1, wherein:
the first average temperature is from 400° C. to 500° C.;
the second average temperature is from 450° C. to 550° C.;
the third average temperature 500° C. to 600° C.;
the first average oxygen concentration is from 0 mol. % to 4 mol. %;
the second average oxygen concentration is from 3 mol. % to 8 mol. %; and
the third average oxygen concentration is from 8 mol. % to 14 mol. %.

13. A method for forming propylene, the method comprising:
forming propylene from butene by passing a stream comprising butene into contact with a catalyst system comprising a metathesis catalyst and a cracking catalyst to from propylene;
stopping the reacting of the butene to form propylene; and
removing coke from the catalyst system by a process comprising:
exposing the catalyst system to a de-coking treatment comprising three consecutive treatment conditions comprising a first treatment condition, a second treatment condition, and a third treatment condition, wherein:
the catalyst system comprises a metathesis catalyst and a cracking catalyst;
the first treatment condition comprises a first average temperature and a first average oxygen concentration;
the second treatment condition comprises a second average temperature and a second average oxygen concentration, the first average temperature is less than the second average temperature, and the first average oxygen concentration is less than the second average oxygen concentration;
the third treatment condition comprises a third average temperature and a third average oxygen concentration, the second average temperature is less than the third average temperature, and the second average oxygen concentration is less than the third average oxygen concentration.

14. The method of claim 13, wherein the de-coking treatment forms carbon dioxide gas.

15. The method of claim 13, wherein the catalyst system increases or remains substantially constant in temperature throughout the de-coking treatment.

16. The method of claim 13, wherein the catalyst system is exposed to increasing or substantially constant oxygen concentration throughout the de-coking treatment.

17. The method of claim 13, wherein the third treatment condition has a temperatures of at least 525° C.

18. The method of claim 13, wherein:
the first average temperature is from 400° C. to 500° C.;
the second average temperature is from 450° C. to 550° C.; and
the third average temperature 500° C. to 600° C.

19. The method of claim 13, wherein:
the first average oxygen concentration is from 0 mol. % to 4 mol. %;
the second average oxygen concentration is from 3 mol. % to 8 mol. %; and
the third average oxygen concentration is from 8 mol. % to 14 mol. %.

20. The method of claim 13, wherein:
the first treatment condition has a time of from 5 hours to 10 hours;
the second treatment condition has a time of from 2 hours to 6 hours; and
the third treatment condition has a time of from 5 hours to 10 hours.
